(19) United States
(12) Patent Application Publication
(10) Pub. No.: US 2023/0224341 A1
(43) Pub. Date: Jul. 13, 2023

(54) COMMUNICATION PROTOCOL FOR PROVIDING VIDEO CUSTOMIZED ALERTING TONEST BASED ON EARLY SESSION MODEL

(71) Applicant: SK TELECOM CO., LTD., Seoul (KR)

(72) Inventor: Jeong Woo HWANG, Seoul (KR)

(21) Appl. No.: 18/010,836

(22) PCT Filed: Apr. 15, 2021
(86) PCT No.: PCT/KR2021/004756

§ 371 Date: Dec. 16, 2022

(30) Foreign Application Priority Data
Aug. 7, 2020 (KR) 10-2020-0099262

(51) Int. Cl. H04L 65/1096; H04L 69/24; H04L 65/1104; H04L 65/1069

(52) U.S. Cl. CPC H04L 65/1096; H04L 69/24; H04L 65/1104; H04L 65/1069

(57) ABSTRACT

The present disclosure provides an optimal method of delivering a called party's set video during a voice call connection to the calling party as video Customized Alerting Tones (CAT). More specifically, to generate a video call that delivers the video CAT in the form of early media from a voice call, the disclosure utilizes the early session model suggested by the 3GPP standard to provide a communication protocol for negotiating and establishing a session for the early media. Additionally, the present disclosure provides a method of performing exception handling in a communication protocol for video CAT delivery to ensure calling stability in abnormalities such as errors occurring in the codec negotiation process for video CAT in the network, server failure situations, and user equipment and server malfunctions.

### TECHNICAL FIELD

The present disclosure in some embodiments relates to a communication protocol for providing video customized alerting tones (CAT) based on an early session model. More particularly, the present disclosure relates to delivering, during a voice call connection, the caller side the called party's set video as a video CAT, with a communication protocol for negotiating and setting a session for early media by using an early session model.

### BACKGROUND

The statements in this section merely provide background information related to the present disclosure and do not necessarily constitute prior art.

Customized alerting tones (CAT) are called party's preset ringing tones to be delivered to a calling party, for which media data may be used such as voice, audio, video, etc. With video CAT applied, one may find it difficult to change the voice-outgoing-signal configuration to include video information depending on whether the called party subscribes to the inclusive service. Therefore, the voice outgoing signal needs to be changed to a video outgoing signal, and the incapacity for transmitting video through a voice session established at a voice call request has been resolved by a suggestion of the 3GPP standard. The 3GPP TS 24.182 standard describes a method for delivering CAT as early media from a called party to a calling party by using a forking model and an early session model (as seen in Non-patent document 1).

The forking model discerns the dialogue for early media from the dialogue of the final voice session and instead keeps from generating separate Session Description Protocol (SDP) information of the calling user equipment (UE), for use in the dialogue for the early media. Whereas, the early session model does use a separate SDP when establishing a session for the early media in the middle of the call, though it keeps from discerning the dialogue for the early media from the dialogue of the final voice session.

Therefore, to use a video image as an alerting tone during a voice call, the session of the early media needs to be newly changed to the video session, so an early session model-based provision of video is advantageous. An operation scheme for the early session model follows the 3GPP standard (as seen in Non-Patent Document 1). Although the 3GPP standard describes the situation with vocal early media, it does not consider the change of session information from voice to video and vice versa. Therefore, the 3GPP standard does not specify how to deliver the SDP of a content server to the UE and how to change the session.

To remedy the deficiency, it is most common for the Telephony Application Server (TAS) of the called network to establish a separate session with the content server, and load the SDP received in the process of establishing the session to the call control message. However, codec information of the content server may be obtained after the TAS establishes at least one session with the content server. Therefore, switching to video content needs a session update to be performed with the content server. The common remedy is susceptible to delayed calls due to such an additional session establishment and performance degradation due to an additional transaction.

In addition to the establishment of a Session Initiation Protocol (SIP) session according to the standard, there is a way to utilize the 3G, LTE, or 5G data network for a software calling application to directly play a video corresponding to the CAT and to stop the video playback at the initiation of a call between the caller and the called party. However, where a lack of data communication provides no video playback, the IP multimedia subsystem (IMS) call network, unable to recognize this situation, may control the call by assuming that the video is being played, which causes silence to occur.

Therefore, an effective call flow is required to provide a highly effective service by solving deficiencies due to session establishment between the TAS (Telephony Application Server) and the content server.

### PRIOR ART LITERATURE

### Non-Patent Documents

Non-patent document 1: TS 24.182, 3rd Generation Partnership Project; Technical Specification Group Core Network and Terminals; IP Multimedia Subsystem (IMS) Customized Alerting Tones (CAT); Protocol specification (Release 16).

### DISCLOSURE

### Technical Problem

The present disclosure in at least one embodiment provides an optimal method of delivering a called party's set video during a voice call connection as video CAT (Customized Alerting Tones) to the calling party. More specifically, the present disclosure in some embodiments seeks to provide a communication protocol for negotiating and establishing a session for early media by taking advantage of the early session model suggested by the 3GPP standard, to generate, from a voice call, a video call that delivers the video CAT in the form of early media.

Further, according to another embodiment, the present disclosure aims to improve methods of establishing a session for early media delivery with the early session model as presented in the 3GPP standard with a reduction in the burden on the network due to the transaction added in the process and the time and cost required for the transaction by providing a communication protocol with an appropriate reduction of some of the process of a further round of updating the session of the content server.

According to embodiments, the present disclosure further aims to provide methods of performing exception handling on exceptions in the communication protocol for video CAT delivery, to secure call stability in such exceptions as errors occurring in the codec negotiation process for video CAT in the network, server failure situations, and malfunctioning conditions of UEs and servers, etc.

### SUMMARY

At least one aspect of the present disclosure provides a method performed by an application server for providing early media during a session initiation protocol-based (SIP-based) call connection between a calling user equipment (UE) and a called UE, the method including receiving a first INVITE message including a session description protocol (SDP) information of the calling UE, performing a procedure for establishing an early session for capability negotiation with the calling UE to provide a video as the early media, and when the early session is established successfully, providing the early media to the calling UE based on a capability negotiated by using the early session. Here, the procedure for establishing the early session includes transmitting, to the calling UE, an early session offer message including a first SDP information specifying one or more video codecs available for the early media, and receiving an early session answer message including a second SDP information specifying one or more codecs supported by the calling UE and to be used for the early media.

Another aspect of the present disclosure provides the method of providing early media further including terminating the provision of the early media upon receiving a message 200 OK including SDP information of the called UE as a response to the first INVITE message.

Yet another aspect of the present disclosure provides a method performed by a calling user equipment (UE) for receiving early media during a session initiation protocol-based (SIP-based) call connection between the calling UE and a called UE, the method including transmitting an INVITE message including a session description protocol (SDP) information of the calling UE and header information indicating that an early session is supported, receiving, from an application server, an early session offer message including a first SDP information specifying one or more video codecs available for the early media, and transmitting, to the application server, an early session answer message including a second SDP information about one or more codecs supported by the calling UE and to be used for the early media.

Yet another aspect of the present disclosure provides a computer capable of reading a medium storing a computer program including computer-executable instructions, when being executed in the computer, cause the computer to perform a method by a calling user equipment (UE) for receiving early media during a session initiation protocol-based (SIP-based) call connection between the calling UE and a called UE, the method including transmitting an INVITE message including a session description protocol (SDP) information of the calling UE and header information indicating that an early session is supported, receiving, from an application server, an early session offer message including a first SDP information specifying one or more video codecs available for the early media, and transmitting, to the application server, an early session answer message including a second SDP information about one or more codecs supported by the calling UE and to be used for the early media.

Yet another aspect of the present disclosure provides a method performed by a network call processing apparatus for processing a session initiation protocol-based (SIP-based) call, the method including receiving, from a calling user equipment (UE), a first INVITE message including a session description protocol (SDP) information of the calling UE and header information indicating whether an early session is supported, when the header information indicates that the early session is supported by the calling UE, transmitting a second INVITE message including the SDP information of the calling UE to an application server and a called UE, upon receiving from the application server an early session offer message including a first SDP information specifying one or more video codecs available for early media, transmitting the early session offer message to the calling UE, upon receiving from the calling UE an early session answer message including a second SDP information specifying one or more codecs supported by the calling UE and to be used for the early media, transmitting the early session answer message to the application server, and upon receiving from the called UE a message 200 OK including SDP information of the called UE in response to the second INVITE message, transmitting the message 200 OK to the application server and the calling UE.

Yet another aspect of the present disclosure provides a non-transitory computer-readable medium storing computer-executable instructions, when being executed by a computer, cause the computer to perform a method performed by an application server for providing early media during a session initiation protocol-based (SIP-based) call connection between a calling user equipment (UE) and a called UE, the method including receiving a first INVITE message including a session description protocol (SDP) information of the calling UE, performing a procedure for establishing an early session for capability negotiation with the calling UE to provide a video as the early media, and when the early session is established successfully, providing the early media to the calling UE based on a capability negotiated by using the early session. Here the procedure for establishing the early session includes transmitting, to the calling UE, an early session offer message including a first SDP information specifying one or more video codecs available for the early media, and receiving an early session answer message including a second SDP information specifying one or more codecs supported by the calling UE and to be used for the early media.

Yet another aspect of the present disclosure provides a non-transitory computer-readable medium storing computer-executable instructions, when being executed by a computer, cause the computer to perform a method by a calling user equipment (UE) for receiving early media during a session initiation protocol-based (SIP-based) call connection between the calling UE and a called UE, the method including transmitting an INVITE message including a session description protocol (SDP) information of the calling UE and header information indicating that an early session is supported, receiving, from an application server, an early session offer message including a first SDP information specifying one or more video codecs available for the early media, and transmitting, to the application server, an early session answer message including a second SDP information about one or more codecs supported by the calling UE and to be used for the early media.

Yet another aspect of the present disclosure provides a non-transitory computer-readable medium storing computer-executable instructions, when being executed by a computer, cause the computer to perform a method by a network call processing apparatus for processing a session initiation protocol-based (SIP-based) call, the method including receiving, from a calling user equipment (UE), a first INVITE message including a session description protocol (SDP) information of the calling UE and header information indicating whether an early session is supported, when the header information indicates that the early session is supported by the calling UE, transmitting a second INVITE message including the SDP information of the calling UE to an application server and a called UE, upon receiving from the application server an early session offer message including a first SDP information specifying one or more video codecs available for early media, transmitting the early session offer message to the calling UE, upon receiving from the calling UE an early session answer message including a second SDP information specifying one or more codecs supported by the calling UE and to be used for the early media, transmitting the early session answer message to the application server, and upon receiving from the called UE a message 200 OK including SDP information of the called UE in response to the second INVITE message, transmitting the message 200 OK to the application server and the calling UE.

### Advantageous Effects

As described above, according to at least one embodiment, the present disclosure can take advantage of the early session model suggested by the 3GPP standard to provide a communication protocol for negotiating and establishing a session for early media, thereby enabling to change a voice call into a video call for early media delivery and to transfer the called party's set video as video CAT to the calling party.

In another aspect, the present disclosure can improve the method of establishing a session for early media delivery with the early session model as presented in the 3GPP standard, by providing the communication protocol with an appropriate reduction of some of the process of a further round of updating the session of the content server, thereby reducing the burden on the network due to the transaction added in the process and the time and cost required for the transaction.

In some other aspects, the present disclosure can provide methods of performing exception handling on exceptions in the communication protocol for video CAT delivery, such as errors occurring in the codec negotiation process for video CAT in the network, server failure situations, and malfunctioning conditions of the UEs and the servers, etc., thereby securing call stability in the aforementioned exceptions.

### BRIEF DESCRIPTION OF THE DRAWINGS

FIG. 1 is a block diagram of a service system for providing early media according to at least one embodiment of the present disclosure.

FIGS. 2A and 2B are a flowchart sequentially illustrating a method of providing early media according to at least one embodiment of the present disclosure.

FIGS. 3A and 3B are a flowchart of a method of performing an exception handling when an application server fails to establish a session with a content server, according to at least one embodiment of the present disclosure.

FIGS. 4A and 4B are a flowchart of a method of performing an exception handling at an error occurrence in video playback with a calling UE, according to at least one embodiment of the present disclosure.

FIGS. 5A and 5B are a flowchart of a method of performing an exception handling at an error occurrence in session processing with a calling UE, according to at least one embodiment of the present disclosure.

[REFERENCE NUMERALS]

| | | | |
|---|---|---|---|
| 100: | Service system for providing | | |
| | early media | | |
| 102: | calling user equipment (UE A) | 104: | SIP server |
| 106: | application server | 107: | SIP core |
| 108: | content server | 110: | called user equipment |
| | | | (UE B) |

### DETAILED DESCRIPTION

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

The description of the present disclosure to be presented below in conjunction with the accompanying drawings is intended to describe exemplary embodiments of the present disclosure and is not intended to represent the only embodiments in which the technical idea of the present disclosure may be practiced.

This embodiment illustrates a communication protocol for delivering a called party's set video during a voice call connection as video CAT (Customized Alerting Tones) to the caller side. In more detail, to generate, from a voice call, a video call that delivers the video CAT in the form of early media, the present embodiment utilizes an early session model suggested by the 3GPP standard to provide a communication protocol for negotiating and establishing a session for the early media.

Hereinafter, the service means to provide video CAT in the form of early media.

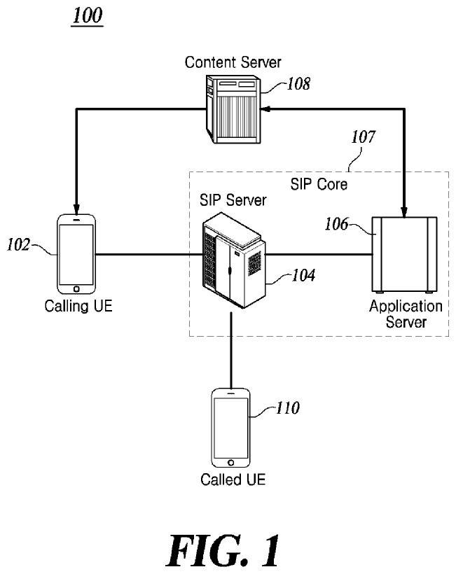

FIG. 1 is a block diagram of a service system 100 for providing early media according to at least one embodiment of the present disclosure.

The service system 100 for providing early media (hereinafter, ‘service system’) according to the present disclosure performs, based on Session Initiation Protocol (SIP), a communication protocol for providing video CAT in an early media form. The service system 100 includes a SIP server 104, an application server 106 (hereinafter, denoted interchangeably with ‘AS’), and a content server 108 in whole or in part. Further, the service system 100 may include, as the early-media service subjects, a calling UE 102 (hereinafter, denoted interchangeably with ‘UE A’) and a called UE 110 (hereinafter denoted interchangeably with ‘UE B’). Meanwhile, a SIP core 107 is so called by encompassing the SIP server 104 and the application server 106 involved in the call flow with the UEs based on SIP.

The calling UE 102 is a terminal that receives early media according to the present disclosure, and it may have a level of performance capable of receiving and playing back early media in the form of video CAT. The calling UE 102 may receive and playback video data provided as early media and thereby notify the subscriber of the calling UE 102 that a call connection request to the called UE 110 is in progress. Here, the video data may include images, videos, and flash animations that can be played on the screen of the calling UE 102.

The called UE 110 is a terminal for a subscriber who has pre-subscribed to a service for providing early media. When the calling UE 102 requests a call connection, the called UE's (110) set service information is used until the same connection is established, to provide early media to the calling UE 102.

The SIP server 104 is an apparatus for routing a message performing a Call Session Control Function (CSCF) between the calling UE 102, the called UE 110, and the application server 106. The SIP server 104 includes Proxy-CSCF (P-CSCF, not shown) that acts on behalf of subscribers and controls Quality of Service (QoS), and Interrogating/Serving-CSCF (I/S-CSCF, not shown) that performs main functions for call processing.

Among the main methods of SIP used in the present disclosure are an ‘INVITE’ for inviting a service or user to participate in a session, an ‘ACK’ for confirming the receipt of a final response (‘200 OK’) to an INVITE request, an ‘INFO’ for transmitting additional information within an established session or dialogue, a ‘PRACK’ for temporarily approving a response by the calling UE, and a ‘BYE’ for terminating a preset session.

Among the main responses of the SIP used in the present disclosure are a ‘ message 180’ delivered by the called UE to the calling UE to indicate that the called UE is ringing to the initiating user, a ‘message 183’ that is a provisional response for transmitting other call progress information, a ‘message 200 OK’ for notifying that the request has been processed normally, a ‘message 4XX’ for conveying an error condition, and a ‘message 5XX’ for notifying that the relevant service has not been implemented.

For example, the SIP server 104 transmits the INVITE message received from the calling UE 102 over to the application server 106 and forwards the INVITE message from the application server 106 over to the called UE.

Additionally, when receiving the INVITE message from the calling UE 102, the SIP server 104 may check whether or not the subscriber of the called UE 110 to receive that message has the service subscription for providing early media. When the subscriber of the called UE 110 is not subscribed to the service for providing the video CAT according to the present disclosure, the SIP server 104 may perform procedures for providing the relevant calling UE 102 with the conventional early media such as voice and audio data. The following focuses on a case where the subscriber of the called UE 110 subscribes to the service according to the present disclosure.

The application server 106 performs, based on SIP, individual processing and management on the operation of the calling UE 102 and the called UE 110. For the calling UE to be provided with early media according to the called UE (110) subscriber's set service information by using an early/regular session, the application server 106 transmits and receives messages to and from the content server 108 and performs the procedure of setting a session with the calling UE 102.

To provide a call between the calling UE 102 and the called UE 110, the present disclosure may have its session separated into an early session and a regular session. Here, the early session means a separate session for providing early media, and the regular session means a session for a regular call (a voice call in the present disclosure) between two UEs. For UEs that do not support early sessions, early media may be provided by using ordinary regular sessions without separate early sessions, which is a forking model. For UEs that support early sessions, early media may be provided by using the early session established following separate session negotiation procedures, which is an early session model. As described above, the present disclosure assumes the use of UEs supporting the early session model.

The application server 106 may analyze the header information of the INVITE message received from the calling UE 102 and thereby confirm whether the calling UE 102 supports the early session model and the capability or incapacity for video early media reception, to determine whether to perform service provision using the early session.

The content server 108 is an apparatus that exchanges messages with the application server 106 and provides early media to the calling UE 102. For example, the content server 108 may provide media information for service provision by using message communication with the application server 106, and it may follow media provision instructions from the application server 106 and provide early media to the calling UE 102.

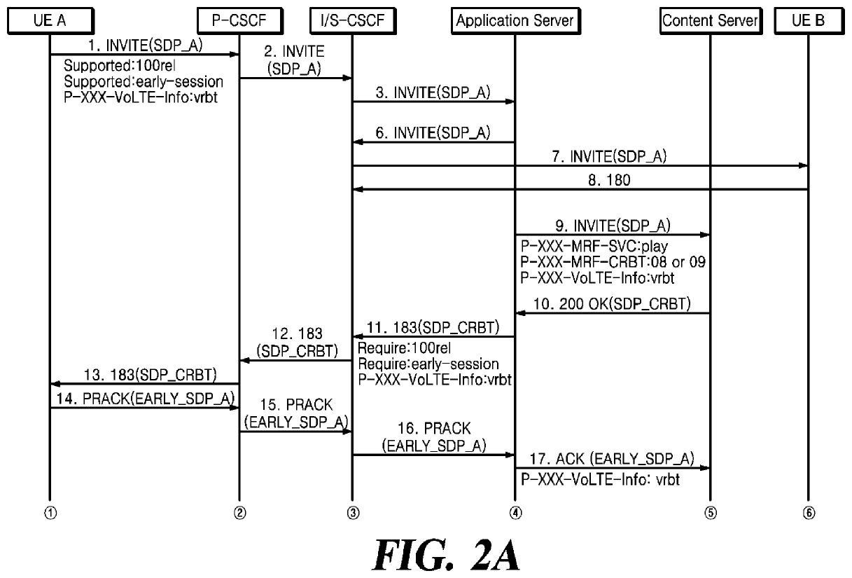

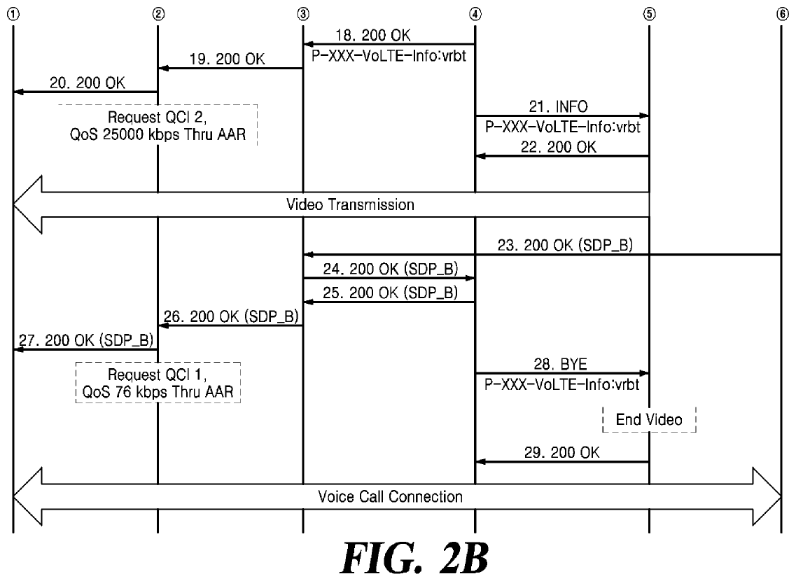

FIGS. 2A and 2B are a flowchart sequentially illustrating a method of providing early media according to at least one embodiment of the present disclosure.

The UE A or calling UE 102 delivers the INVITE message including the SDP information of the calling UE 102 to the SIP server 104 for a call connection (Step 1). As described above, the SIP server 104 indicates P-CSCF and I/S-CSCF illustrated in FIG. 2A.

The INVITE message transmitted by the calling UE 102 may include, for example, an IP address of the calling UE, called-UE information, a service processing identifier, and Session Description Protocol (SDP) information of the calling UE. Here, the IP address of the calling UE means an address value for identifying the calling UE when performing Transmission Control Protocol/Internet Protocol (TCP/IP) based communication, and the called-UE information may include the phone number of the called UE. The service processing identifier is information on a service supported by the calling UE, wherein the service may be, for example, support of an early session for providing early media.

The calling UE 102 capable of supporting the video CAT service needs to specify its reception capability of early media by using the early session model by including a header of ‘Supported: early-session’ as a service processing identifier in the INVITE message. Additionally, if necessary, the calling UE 102 may insert a separate private header into the INVITE message to designate the possession of early media reception capability. For example, in the illustration of FIG. 2A (Step 1), ‘P-XXX-VoLTE-Info: vrbt’ included in the INVITE message of the calling UE 102 represents a private header related to ‘Voice over LTE’ (VoLTE) and supporting ‘video ringback tone’ (vrbt), that is, video CAT. In general, ‘XXX’ may indicate an organization, company, etc. that introduced this private header. Meanwhile, the ‘Supported: 100rel’ header is an option tag indicating the supportability of PRACK, a reliable provisional ACK.

The SIP server 104 receives the INVITE message from the calling UE 102 (Step 1) and is responsive to when the called UE's (110) subscriber subscribes to a service for providing early media, for transmitting the INVITE message to the application server 106 (Steps 2 and 3), and receiving and forwarding the INVITE message from the application server 106 (Step 6) to the called UE 110 (Step 7).

The application server 106 receives the INVITE message containing the SDP information of the calling UE 102 (Step 3). When the called UE's (110) subscriber is subscribed to the video CAT service, the application server 106 analyzes the header included in the INVITE message and the private header to perform a procedure for determining whether or not the calling UE 102 is capable of supporting the early session and whether or not the calling UE 102 is capable of receiving the video as early media.

When determining against the video CAT service-capable calling UE 102 that the called UE's (110) subscriber has a subscription to the service for providing video CAT, the application server 106 delivers the incoming INVITE message to the called UE 110 via the SIP server 104 (Steps 6 and 7).

The called UE 110 in receipt of the incoming INVITE message forwards the message 180 to the SIP server 104 to indicate that ringing is in progress. Meanwhile, establishing a regular session for a voice call requires a call flow for an incoming connection following the delivery of message 180. For the incoming connection, the SIP server 104 needs process steps including transmitting the message 180 to the application server 106 and sending the called UE an ACK message by the calling UE having received from the called UE the message 200 OK corresponding to call acceptance. However, the call flow for an incoming connection is not shown in FIGS. 2A and 2B since it is out of the scope of the present disclosure, and no further detailed description thereof will be presented.

The application server 106 transmits the INVITE message for establishing a video session for the early media to the content server 108 (Step 9). At this time, the application server 106 may include separate private headers in the INVITE message sent to the content server 108 and thereby notify that the video content should be provided as early media.

For example, included in the INVITE message sent to the content server 108 as illustrated in FIG. 2A at Step 9, ‘P-XXX-MRF-SVC: play’, ‘P-XXX-MRF-CRBT: 08 or 09’, and the like are the private headers. Here, MRF is another notation for the content server 108.

Depending on the content of the private headers, the content server 108 returns a message 200 OK including a Session Description Protocol (SDP) for available video codec information to the application server 106 (Step 10).

Before sending the content server 108 the ACK message for the received message 200 OK, the application server 106 performs a procedure for establishing an early session with the calling UE 102. First, the application server 106 transmits a message 183 to the calling UE 102 via the SIP server 104 (Steps 11 to 13). At this time, the application server 106 performs a function of offering early session establishment by including ‘Require: 100rel’, ‘Require: early-session’, if there is a private header delivered from the calling UE 102, the private header, and the video-related SDP within the message 200 OK delivered from the content server 108, in the message 183. However, when the network does not support the early session model, the present disclosure may hold ‘Require: early-session’ from the early media providing method and thereby allow the general voice/audio CAT operation to be performed based on the forking model.

In response, the calling UE 102 may set a codec available for negotiation among the codecs delivered on the message 183 and then send the application server 106 a PRACK message including SDP information specifying the set codec via the SIP server 104, and thereby answer the proposal of an early session establishment.

Upon receiving the PRACK message, the application server 106 sends the content server 108 an ACK message including SDP information designated by the PRACK message (Step 17). The content server 108 may establish an early session based on that ACK message. The content server 108 may provide video CAT when a video codec is present in the codec information of the ACK message but may provide a voice/audio CAT service if there is no video codec.

Upon transmitting the ACK message, the application server 106 forwards the message 200 OK for the PRACK message to the calling UE 102 via the SIP server 104 (Steps 18 to 20) to finalize the procedure for early session establishment. Meanwhile, in response to the message 200 OK for the PRACK message and based on the negotiated codec information, the P-CSCF in the SIP server 104 may set the QoS for the video CAT by using a Policy and Charging Rule Function (PCRF, not shown) and an Authorize/Authenticate Request (AAR) message.

The application server 106 requests the content server 108 for the transmission of a video corresponding to the early media by using the INFO message (Step 21). The content server 108 transmits the message 200 OK for the INFO message to the application server 106 (Step 22), and then transmits the video requested on the INFO message toward the SDP's address received on the ACK message, and in general, to the calling UE 102 or the IP/PORT of the P-CSCF in the SIP server 104.

After the subscriber's call acceptance (e.g., off-hook, touch on a call button, etc.), the called UE 110 sends the SIP server 104 the message 200 OK as a response to the incoming INVITE message (Step 23). In this case, the message 200 OK corresponding to the call acceptance includes voice SDP information of the called UE 110.

The SIP server 104 receives the message 200 OK from the called UE 110 (Step 23) and transmits the same to the application server 106 (Step 24). The application server 106 receives the message 200 OK including the voice SDP information of the called UE 110 and delivers the same to the calling UE 102 (Steps 25 to 27).

Upon receiving the message 200 OK for the call acceptance of the called UE 110, the P-CSCF in the SIP server 104 may set the voice QoS for the call by again using the PCRF and the Authorize/Authenticate Request (AAR) message.

The application server 106 delivers the message 200 OK to the calling UE 102 and then ends the early session by delivering a BYE message to the content server 108 (Step 28), thereby inducing the regular session to be established for the voice call.

As described above, according to at least one embodiment, the present disclosure can take advantage of the early session model suggested by the 3GPP standard to provide a communication protocol for negotiating and establishing a session for early media, thereby enabling to change a voice call into a video call for early media delivery and to transfer the called party's set video as video CAT to the calling party.

Additionally, according to at least one embodiment, the present disclosure can improve the method of establishing a session for early media delivery with the early session model as presented in the 3GPP standard, by providing the communication protocol with an appropriate reduction of some of the process of a further round of updating the session of the content server, thereby reducing the burden on the network due to the transaction added in the process and the time and cost required for the transaction.

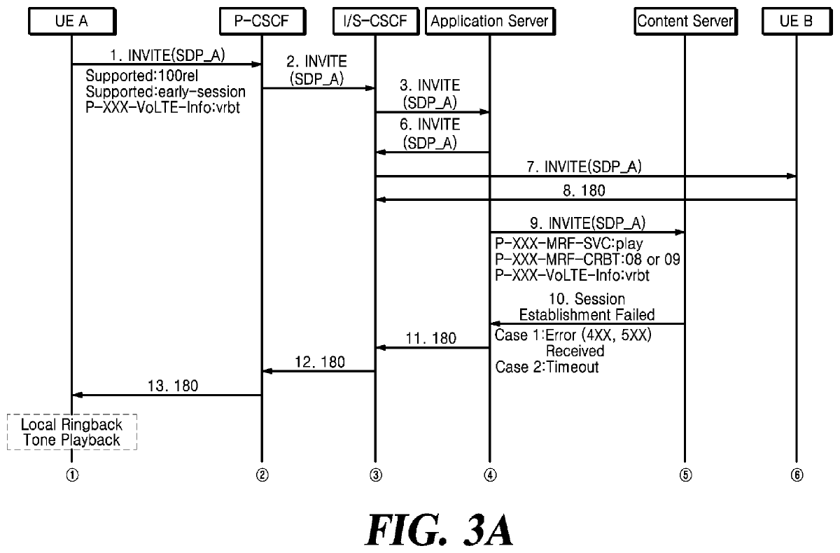

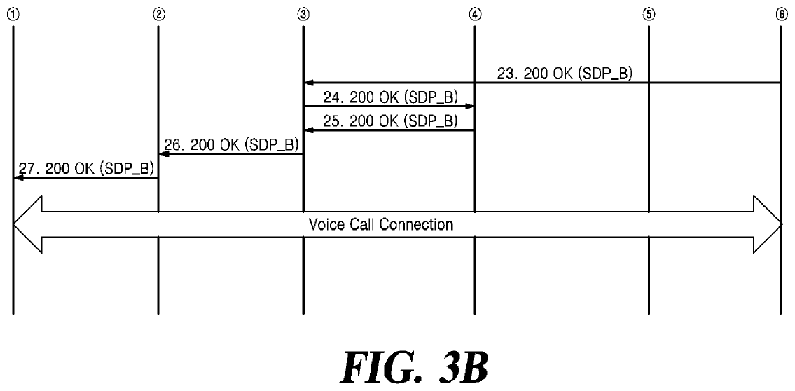

The following describes using the flowcharts of FIGS. 3A to 5B methods of performing exception handling to ensure call stability in an error situation that may occur with a service in progress for providing early media.

FIGS. 3A and 3B are a flowchart of a method of performing an exception handling when the application server fails to establish a session with a content server, according to at least one embodiment of the present disclosure.

The application server 106 may transmit the INVITE message for establishing a video session for the early media to the content server 108 (Step 9), subsequently expecting a message 200 OK from the content server 108, but the video session establishment may fail due to the error (in receiving a message 4XX or 5XX) or timeout (Step 10). In this case, the application server 106 may transmit the message 180 to the calling UE 102 (Steps 11 to 13) to induce a local ringback tone to be played back. Here, the local ringback tone is, for example, a ringback tone that the calling UE 102 can provide to the subscriber when provided with no available CAT, e.g., video data, or audio or voice data according to the present embodiment. The local ringback tone may be audio or voice data that is stored by the calling UE 102.

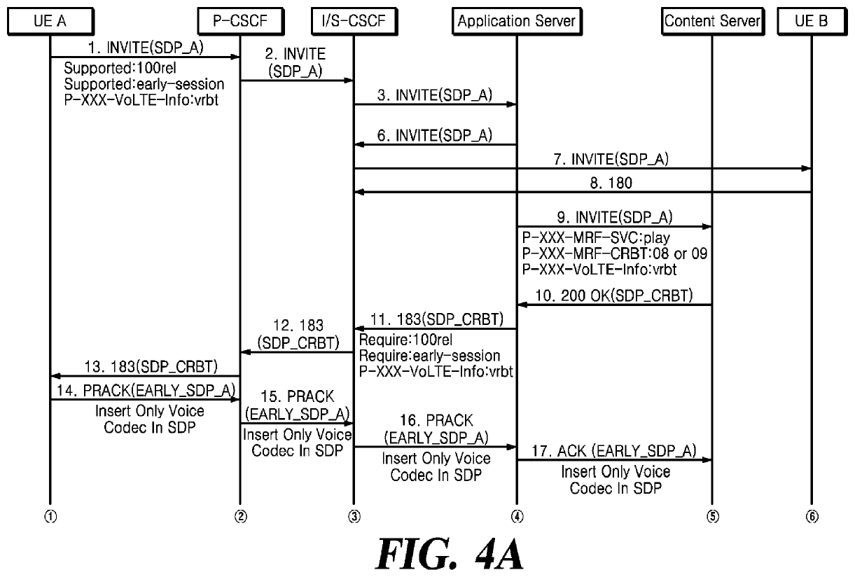

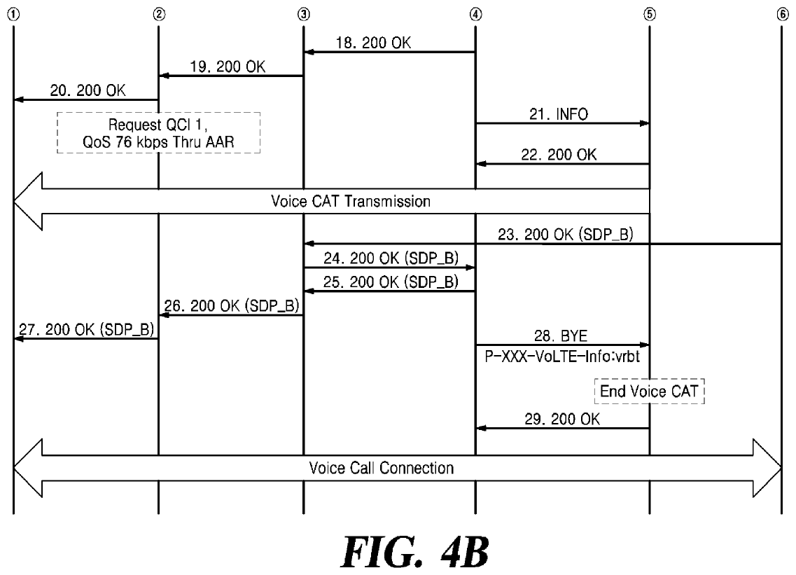

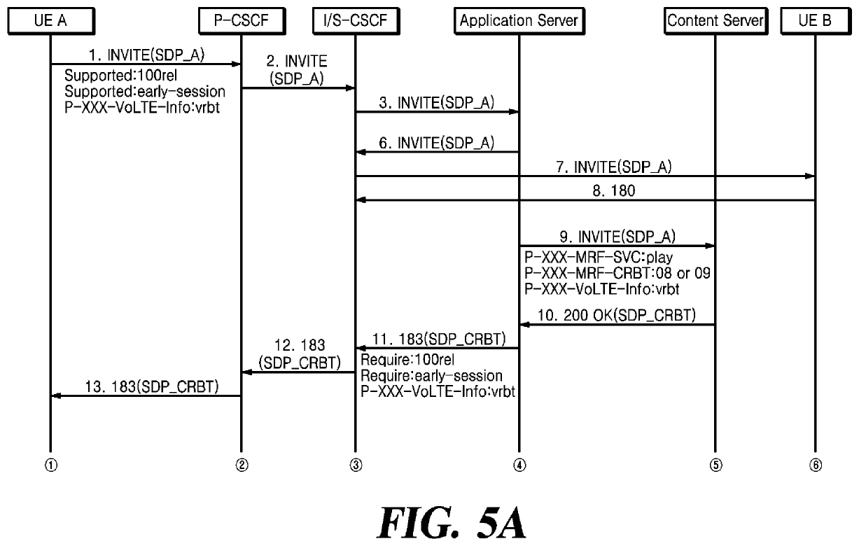

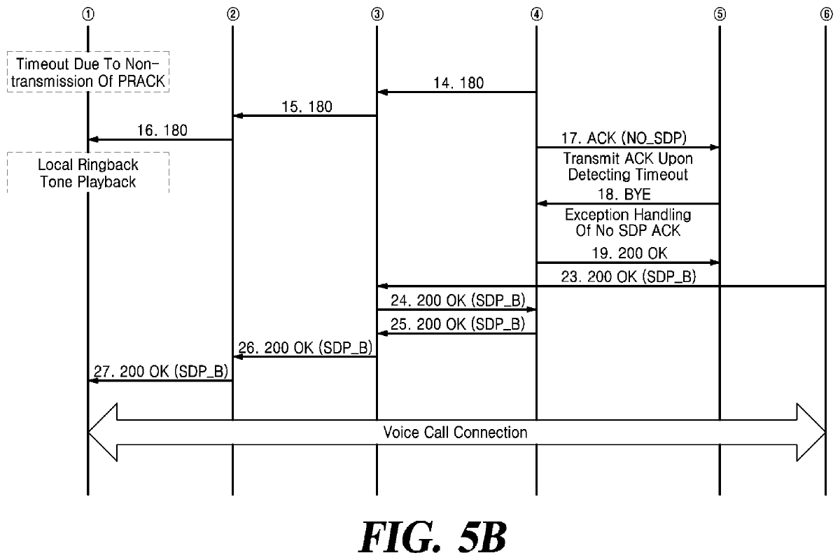

When the calling UE 102 in receipt of the message 183 suggesting the early session does not possess a negotiable video codec or cannot properly accommodate the early media due to an operational error, the calling UE 102 may perform one of two methods as shown by the flowchart of FIGS. 4A and 4B or the flowchart of FIGS. 5A and 5B.

FIGS. 4A and 4B are a flowchart of a method of performing an exception handling at an error occurrence in video playback with the calling UE, according to at least one embodiment of the present disclosure.

When having no negotiable video codec in possession, the calling UE 102 may reply to the application server 106 by specifying only the available voice codec in the PRACK message (Steps 14 to 16). Since this is a situation where no early media is available to provide by using video, the calling UE 102 may induce the provision of early media with voice if it has an available voice codec.

Upon receiving the PRACK message, the application server 106 sends the content server 108 the ACK message including the SDP containing the voice codec designated by the PRACK message (Step 17).

The content server 108 having received the ACK message including only the voice codec may confirm that the calling UE 102 cannot receive the video, and the content server 108 may establish an early session for providing a voice CAT service if it is available for use.

Upon transmitting the ACK message, the application server 106 forwards the message 200 OK for the PRACK message to the calling UE 102 (Steps 18 to 20). At this time, in response to the message 200 OK for the PRACK message, the P-CSCF in the SIP server 104 may set, based on the negotiated codec information, the QoS for the voice CAT by using a PCRF and an AAR message.

If no voice codec is available for use, the content server 108 may deliver the BYE message to the application server 106, and when the video CAT session ends, the content server 108 may deliver the message 180 to the calling UE 102, thereby inducing the local ringback tone to be played back.

FIGS. 5A and 5B are a flowchart of a method of performing an exception handling at an error occurrence in session processing with the calling UE, according to at least one embodiment of the present disclosure.

When a session processing error occurs due to a malfunction, etc., the calling UE 102 does not transmit a PRACK message, thereby allowing the application server 106 to recognize a timeout and send the message 180 to the calling UE 102 (Steps 14 to 16). Upon receiving the message 180, the calling UE 102 plays a local ringback tone.

Having detected the timeout, the application server 106 notifies the detection by transmitting an ACK message that contains no SDP information to the content server 108 (Step 17). The content server 108 may terminate the process related to the early session by delivering the BYE message to the application server 106 (Step 18).

As described above, according to some embodiments, the present disclosure can provide methods of performing an exception handling on exceptions in the communication protocol for video CAT delivery, such as errors occurring in the codec negotiation process for video CAT in the network, server failure situations, and malfunctioning conditions of the UEs and the servers, etc., thereby securing call stability in the aforementioned exceptions.

Although some embodiments of the present disclosure present flowcharts with the steps thereof illustrated as being sequentially performed, they merely instantiate the technical idea of some embodiments of the present disclosure. Therefore, a person having ordinary skill in the pertinent art could incorporate various modifications, additions, and substitutions in practicing the present disclosure by changing the sequence of steps described by the respective flowcharts or by performing one or more of the steps in the flowcharts in parallel, and hence the steps in the respective flowcharts are not limited to the illustrated chronological sequences.

Various implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) contain instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. Further, the computer-readable recording medium can be distributed in computer systems connected via a network, wherein the computer-readable codes can be stored and executed in a distributed mode.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

### CROSS-REFERENCE TO RELATED APPLICATION

This application claims priority from Korean Patent Application No. 10-2020-0099262 filed on Aug. 7, 2020, the disclosure of which is incorporated by reference herein in its entirety.

1. A method performed by an application server for providing early media during a session initiation protocol-based (SIP-based) call connection between a calling user equipment (UE) and a called UE, the method comprising:
receiving a first INVITE message including a session description protocol (SDP) information of the calling UE;
performing a procedure for establishing an early session for capability negotiation with the calling UE to provide a video as the early media; and
when the early session is established successfully, providing the early media to the calling UE based on a capability negotiated by using the early session,
wherein the procedure for establishing the early session comprises:
transmitting, to the calling UE, an early session offer message including a first SDP information specifying one or more video codecs available for the early media; and
receiving an early session answer message including a second SDP information specifying one or more codecs supported by the calling UE and to be used for the early media.

2. The method of claim 1, further comprising:
terminating the provision of the early media upon receiving a message 200 OK including SDP information of the called UE as a response to the first INVITE message.

3. The method of claim 1, wherein the early session offer message is a provisional response message 183, and the early session answer message is a PRACK message.

4. The method of claim 1, wherein the early session offer message comprises:
a header for designating that the early session is required;
private headers for designating that a video be provided as early media; and
the first SDP information.

5. The method of claim 1, further comprising:
when the early session fails to be established, transmitting a ringing message to the calling UE to induce a local ringback tone to be played back.

6. The method of claim 1, wherein the performing of the procedure for establishing the early session obtains the first SDP information by further comprising:
transmitting, to the content server, a second INVITE message including a private header specifying that the video be provided as early media; and
receiving, from the content server, a message 200 OK including the first SDP information as a response to the second INVITE message.

7. The method of claim 6, wherein the providing of the early media comprises:
transmitting, to the content server, an ACK message including the second SDP information as a response to the message 200 OK for allowing the content server to transmit the early media by using a codec supported by the calling UE.

8. The method of claim 6, further comprising:
when the early session fails to be established due to non-reception of the early session answer message within a predefined time,
transmitting a ringing message to the calling UE to induce a local ringback tone to be played back; and
transmitting, to the content server, an ACK message including no SDP information as a response to the message 200 OK.

9. The method of claim 1, wherein the providing of the early media comprises:
when the second SDP information includes at least one video codec, providing a video encoded by using the at least one video codec as the early media; and
when the second SDP information includes only a voice codec, providing a voice encoded by using the voice codec as the early media.

10. A method performed by a calling user equipment (UE) for receiving early media during a session initiation protocol-based (SIP-based) call connection between the calling UE and a called UE, the method comprising:
transmitting an INVITE message including a session description protocol (SDP) information of the calling UE and header information indicating that an early session is supported;
receiving, from an application server, an early session offer message including a first SDP information specifying one or more video codecs available for the early media; and
transmitting, to the application server, an early session answer message including a second SDP information about one or more codecs supported by the calling UE and to be used for the early media.

11. A method performed by a network call processing apparatus for processing a session initiation protocol-based (SIP-based) call, the method comprising:
receiving, from a calling user equipment (UE), a first INVITE message including a session description protocol (SDP) information of the calling UE and header information indicating whether an early session is supported;
when the header information indicates that the early session is supported by the calling UE, transmitting a second INVITE message including the SDP information of the calling UE to an application server and a called UE;
upon receiving from the application server an early session offer message including a first SDP information specifying one or more video codecs available for early media, transmitting the early session offer message to the calling UE;
upon receiving from the calling UE an early session answer message including a second SDP information specifying one or more codecs supported by the calling UE and to be used for the early media, transmitting the early session answer message to the application server; and
upon receiving from the called UE a message 200 OK including SDP information of the called UE in response to the second INVITE message, transmitting the message 200 OK to the application server and the calling UE.

12. The method of claim 11, further comprising:
when the second SDP information received from the calling UE includes a video codec, setting Quality of Service (QoS) for video early media and maintaining the set QoS until the message 200 OK is received.

13. (canceled)
